(19) United States
(12) Patent Application Publication
(10) Pub. No.: US 2026/0196843 A1
(43) Pub. Date: Jul. 9, 2026

(54) SYSTEMS AND METHODS FOR ALLOCATING ENERGY FROM A PHOTO-VOLTAIC UNIT (PVU) COMPRISING THERMAL STORAGE

(71) Applicant: Schlumberger Technology Corporation, Sugar Land, TX (US)

(72) Inventors: Kashif Rashid, Cambridge, MA (US); Sandeep Verma, Cambridge, MA (US)

(21) Appl. No.: 19/442,615

(22) Filed: Jan. 7, 2026

Related U.S. Application Data
(60) Provisional application No. 63/742,643, filed on Jan. 7, 2025.

(51) Int. Cl. H02J 3/466; H02J 13/10; H02J 101/24; H02J 101/40; H02J 103/35; H02S 10/20; H02S 10/30

(52) U.S. Cl. CPC H02J 3/466; H02J 13/10; H02S 10/20; H02S 10/30; H02J 2101/24; H02J 2101/40; H02J 2103/35

(57) ABSTRACT

A method including receiving input data, setting one or more static properties based on the input data, providing the one or more static properties to a model of one or more components of an energy system, generating a plurality of performance curves, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI. The input data may include one or more fixed data variables, one or more temporal data variables, or any combination thereof. Each performance curve of the plurality of performance curves may also correspond to a respective component of the one or more components.

### CROSS REFERENCE TO RELATED APPLICATIONS

This application claims priority from and the benefit of U.S. Provisional Patent Application No. 63/742,643, entitled “MATHEMATICAL MODELS FOR FIXED CAPACITY ENERGY ALLOCATION”, filed Jan. 7, 2025, which is herein incorporated by reference in its entirety for all purposes.

### BACKGROUND

The present disclosure is generally related to systems and methods for allocating energy. More specifically, the present disclosure is generally related to systems and methods for allocating energy in a long-duration solar energy system using mathematical models including a mixed integer program schema and a rules-based model schema.

A long-duration solar energy system may include a photo-voltaic unit (PVU) and a thermal energy storage (TES) system to supply industrial customers with energy. The PVU generates energy using a mirror field to reflect sunlight to a receiver connected to a central tower. The sunlight reflected from the mirror field to the receiver is converted to electrical energy by the PVU and additionally captures the concentrated thermal energy at the receiver. The thermal energy charges a hot store (e.g. one or more hot water pits). The electrical energy can be used to run a chiller, which may be used to charge a cold store (e.g., cold water pits) or heat pump components of the TES system, which may be used to charge the hot store. Because sunlight does not shine all day and because the long-duration solar energy system may not be able to purchase electricity from another source (e.g., if a grid connection is unavailable), if the long-duration solar energy system is unable to run given these conditions, it will not meet an expected capacity factor (a desired load).

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admission of prior art.

### SUMMARY

A summary of certain embodiments disclosed herein is set forth below. It should be understood that these aspects are presented merely to provide the reader with a brief summary of these embodiments and that these aspects are not intended to limit the scope of this disclosure. Indeed, this disclosure may encompass a variety of aspects that may not be set forth below.

In some embodiments, a system may include a processing system comprising one or more processors and a memory storing instructions that, when executed by the processing system, are configured to cause the processing system to perform operations including receiving input data, setting one or more static properties based on the input data, providing the one or more static properties to a model of one or more components of an energy system, generating a plurality of performance curves, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI. The input data may include one or more fixed data variables, one or more temporal data variables, or any combination thereof. Each performance curve of the plurality of performance curves may also correspond to a respective component of the one or more components.

In some embodiments, a tangible, non-transitory, computer-readable medium comprising instructions that, when executed by processing circuitry, are configured to cause the processing circuitry to perform operations including receiving input data, setting one or more static properties based on the input data, providing the one or more static properties to a model of one or more components of an energy system, generating a plurality of performance curves, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI. The input data may include one or more fixed data variables, one or more temporal data variables, or any combination thereof. Each performance curve of the plurality of performance curves may also correspond to a respective component of the one or more components.

In some embodiments, a method including receiving input data, setting one or more static properties based on the input data, providing the one or more static properties to a model of one or more components of an energy system, generating a plurality of performance curves, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI. The input data may include one or more fixed data variables, one or more temporal data variables, or any combination thereof. Each performance curve of the plurality of performance curves may also correspond to a respective component of the one or more components.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic of a long-duration solar energy system, in accordance with embodiments of the present disclosure;

FIG. 2 illustrates a flow chart of a process for solving a techno-economic model (TEM) of the energy system of FIG. 1, in accordance with embodiments of the present disclosure;

FIG. 3 illustrates a representation of a mixed integer problem (MIP) schema, which may be used in the process of FIG. 2, to yield a high-capacity energy allocation to each component of the long-duration solar energy system of FIG. 1, in accordance with embodiments of the present disclosure;

FIG. 4 illustrates a representation of a rule-based model (RBM) schema, which may be used in the process of FIG. 2, to yield the high-capacity energy allocation to each component of the long-duration solar energy system of FIG. 1, in accordance with embodiments of the present disclosure; and

FIG. 5 illustrates a block diagram of example components of a computing system and their potential interconnections or communication paths, in accordance with the embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

In operation, an energy system generates electricity and heat during the day. The generated energy may be used to run a chiller (for replenishing a cold charge), a heat pump (for replenishing a hot charge) or it may be used to provision a certain load demand (a fixed energy threshold on the site based on contractual terms). The energy system may or may not include a grid connection that enables the sale or purchase of electricity. Thus, in absence of the grid connection to fulfill demand, a fixed capacity energy allocation problem is solved such that the energy threshold is provisioned over a time horizon of interest. Indeed, if the energy system is not capable of meeting the expected capacity factor (stipulated as the percentage of energy delivered over the total expected), the plant may be resized accordingly during the planning phase.

The present embodiments may include mathematical models for the techno-economic evaluation of a PVU-Thermal storage system. In particular, a mixed integer linear program (MIP) model and a rule-based expert system may be modeled to provide a solution for the fixed high-capacity evaluation. The energy may be suitably allocated to meet the load requirements over one-hour intervals over a one year period using the two mathematical models. As such, the techno-economic model evaluation process may be in consideration of plant feasibility in new locations with stipulated energy demands by potential clients.

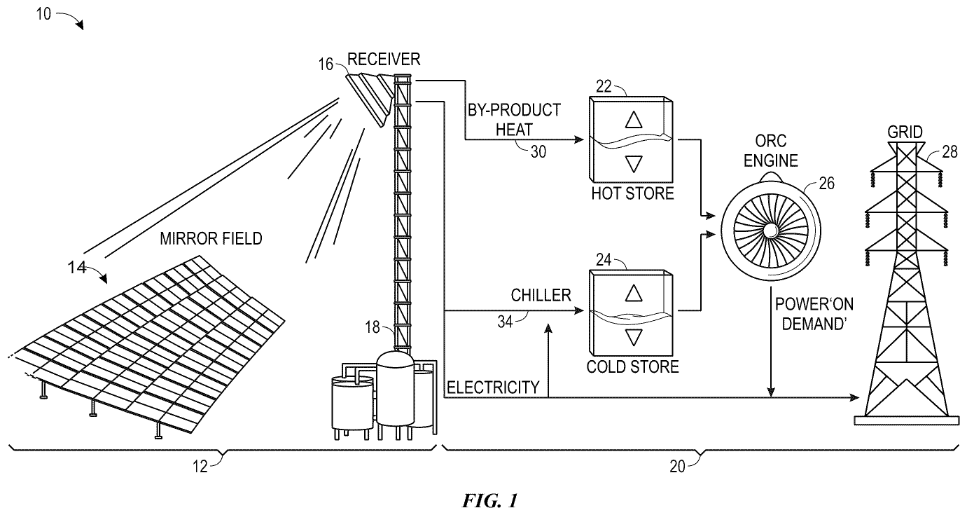

By way of introduction, FIG. 1 illustrates a long-duration solar energy system 10 for generating electricity. The energy system 10 of FIG. 1 may include a photo-voltaic unit (PVU) 12. The PVU 12 includes a mirror field 14 comprising multiple heliostats (i.e., large mirrors) that reflect sunlight to a receiver 16. Each heliostat includes one or more reflective mirrors coupled to a support structure. The heliostats may be singly or doubly curved and may be mounted on a dual-axis tracking system configured to continuously adjust the orientation of the heliostats to follow the sun's path across the sky. As such, the reflected sunlight is continuously reflected from the heliostats of the mirror field 14 to the receiver 16, which may be positioned on a central tower 18. The receiver 16 may include photo-voltaic modules (e.g., groups of photo-voltaic cells) that convert the reflected sunlight into electrical energy. Additionally, the receiver 16 may be configured to collect the concentrated sunlight and direct it to a fluid stream (e.g., molten salt, water, thermal oils, air, and the like) circulating through the receiver 16, which may be configured to absorb heat from the reflected sunlight, resulting in thermal energy.

After electrical and thermal energy is generated from the PVU 12, a thermal energy storage (TES) system 20 may utilize the generated energy. The TES system 20 may include a hot store 22 (e.g., hot water pits), a cold store 24 (e.g., cold water pits), an organic Rankine cycle (ORC) engine 26, and a local grid unit 28, by which the long-duration solar energy system 10 provides energy to customers (locally at the site and more widely by selling to the grid). The hot store 22 of the TES system 20 may be an insulated reservoir of water heated by the thermal energy generated from the PVU 12. The temperature of the hot store 22 may be 60° C., 70° C., 80° C., 90° C., 100° C., 110° C., 120° C., or any other temperature. The cold store 24 may be another insulated reservoir of water chilled by a chiller running on the electrical energy generated from the PVU 12. The cold store 24 may be kept at a temperature of −10° C., 0° C., 10° C., 20° C., or any other temperature. The ORC engine 26 may be the power generation unit for stored energy and may use the temperature difference between the hot store 22 and the cold store 24 to run a thermodynamic cycle with an organic fluid (e.g., ammonia). The fluid may evaporate by taking energy from the hot water from the hot store 22, expanding to drive the turbine of the ORC engine 26, and subsequently condensing with the cold water from the cold store 24, to generate electricity. The generated electricity may be dispatched to meet a local demand or sold to the grid unit 28, or some combination thereof. Because sunlight does not shine all day and because the long-duration solar energy system 10 may not have access to supplemental electricity to feed the long-duration solar energy system 10 when sunlight is not shining on the mirror field 14, if the long-duration solar energy system 10 is unable to run when there is no sunlight, the long-duration solar energy system 10 may not be able meet an expected capacity factor. Accordingly, the present techniques are directed to allocating energy within the long-duration solar energy system 10 such that the long-duration solar energy system 10 meets the expected capacity factor and is able to effectively maintain operation at times when sunlight is not shining on the mirror field 14.

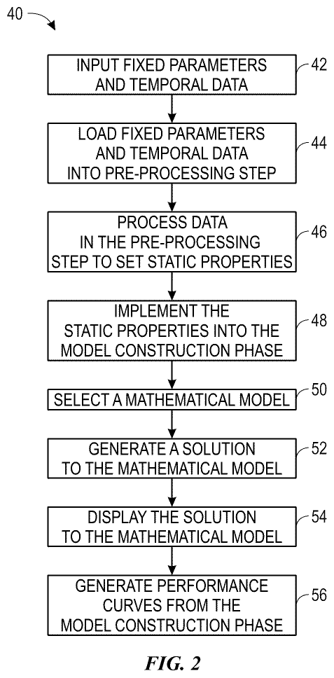

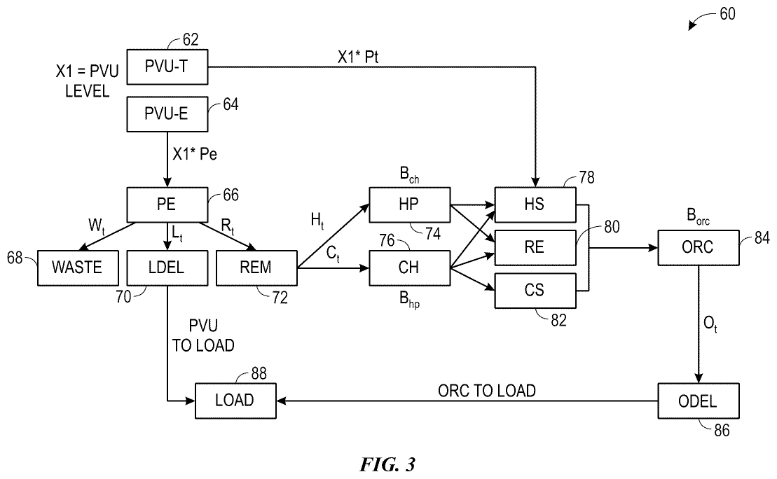

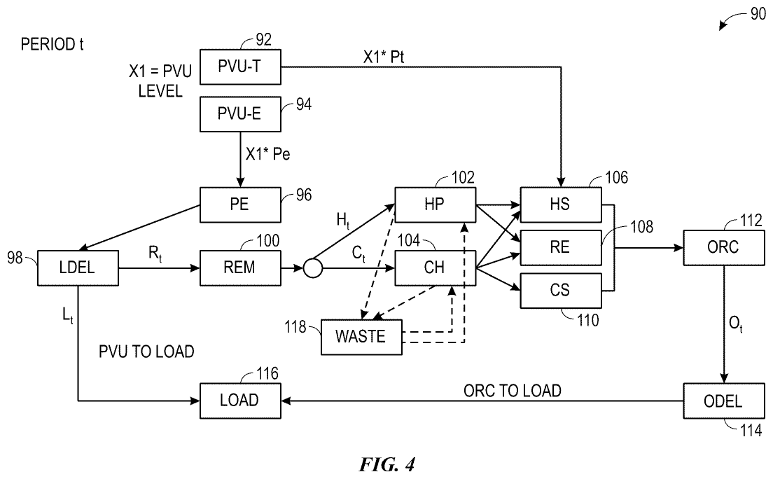

With the forgoing in mind, FIG. 2 illustrates flow chart of a modeling process 40 for solving a techno-economic model (TEM) for the long-duration solar energy system 10 of FIG. 1 by way of a rules-based model (RBM), discussed below with regard to FIG. 4, or a mixed integer program (MIP), discussed below with regard to FIG. 3. At block 42, the one or more fixed parameters and one or more sets of temporal data associated with a site of interest (e.g., the long-duration solar energy system 10 of FIG. 1) may be provided (e.g., via a user interface) to begin the modeling process 40. The one or more fixed parameters may include, for example, pertinent fixed plant and component sizing data at the site of interest, such as a number of hours of storage offered, a load demand, one or more rates for the ORC engine 26, the chiller, and the heat pump, component tolerances, related conditions of the components, and the like. The one or more fixed parameters may be adjusted to reflect the site of interest being modeled. The one or more sets of temporal data may show, via an index, for each hourly period over a year, a solar irradiation intensity in watts per square meter (W/m²), an air temperature in degrees Celsius (° C.), effective electrical and thermal flows from the PVU 12 of the long-duration solar energy system 10 in kilowatts (KW), and so forth.

At block 44, the one or more fixed parameters and the one or more sets of temporal data may be loaded into a pre-processing step to set the static properties for a model construction phase, at block 46. For example, the ORC engine 26, the hot store 22, the cold store 24, and recuperator properties may be established with one or more scale factors and one or more component turndown limits of the site of interest. The properties may include the calculated water mass, the pit volume, the inlet mass, and the like. The scale factors may include the parameters that dictate energy system's performance, the physical size, and the like. The component turndown limits may be the one or more component's ability to operate effectively at a fraction of the one or more components capacity while maintaining stability and acceptable efficiency. For example, the turndown limits may be The ORC engine 26, chiller, and heat pump flowrates going to the cold store 24, hot store 22, or the recuperator may be a function of temperature. More specifically, the ORC engine 26 may be modeled based on three anticipated modes of operation. The three modes of operation may include a first mode (e.g., mode 1), in which the ORC engine is in normal operation with both the recuperator and cold store 24 available, a second mode (e.g., mode 2), in which the recuperator condition is zero (e.g., stored energy in the recuperator is zero), and a third mode (e.g., mode 3), in which the cold store 24 condition is zero (e.g., stored energy in the cold store is zero).

At block 48, the model construction phase is implemented to generate models for each component in the long-duration solar energy system 10 based on mass flows using a process simulator. The process simulator may be any process simulator utilized to generate models for each component of the long-duration solar energy system 10. By way of example, the PVU 12 component may be modeled to show an enthalpy and an equivalent water mass flow relationship. The solar insolation factors may be input to the process simulator as a function of time to calculate the electrical energy generated and mass flowrates of the thermal energy generated from the PVU 12. Other components modeled for heat and mass balance may include, for example, the heat pump, the chiller, the recuperator, the cold store 24, the hot store 22, the ORC engine 26, and the like. As such, the generated models for the heat pump and the chiller may produce performance curves (i.e., coefficient of performance (CoP) curves) that may dictate the component efficiency, power consumed, and hot and cold water flow rates as a function of temperature. The generated models may also produce water flow rates from other components, and the power produced by the ORC engine 26 which may be represented by fitted curves as a function of ambient temperature.

At block 56, the performance curves generated from the models for each component in the long-duration solar energy system 10 from block 48 may be displayed and exported in graphical form. The results from the generated models may also be displayed and exported in tabular form. At block 50, a mathematical model may be selected wherein the selection of mathematical models includes a rules-based model (RBM) and a mixed integer linear program (MIP) to determine where a given quantity of energy may be provisioned in the absence of the local grid unit 28 for a TEM of the energy system 10. At block 52, the solution may be generated using the model selected in block 50. In block 54, the solution generated in block 52 may be read, displayed, and exported.

FIG. 3 illustrates a schematic of a MIP 60 schema described with regard to FIG. 2. The MIP 60 schema may be used to yield a high-capacity energy allocation for each component of the long-duration solar energy system 10. Starting with block 62 and block 64, PVU-T and PVU-E may define the thermal and electrical energy sources from the PVU 12, respectively. The thermal energy source from block 62 may charge the hot store directly at block 78. The electrical energy source from block 64 may be used to provision the electrical energy at a delivery mechanism (at 70), run the heat pump (at 74) or the chiller (at 76), be deemed as wasted energy (at 68), or any combination thereof. The provisioned electrical energy at block 70 may then be allocated to the load (at block 88). The heat pump (at 74) and chiller (at 76) may charge the hot store (at 78), the cold store (at 82), and the recuperator levels (at 80) accordingly. The ORC engine 26 (at 84) may provision the electrical energy at an ORC delivery mechanism (at 84) and provide energy to the load (at 88) as needed.

In the MIP 60 schema, a set of continuous and binary variables may enable decisions over a time period of interest. The continuous and binary variables may activate and operate the levels of the PVU 12, chiller, heat pump, and ORC engine 26 components. The objective of the MIP 60 schema may increase the capacity factor as a percentage of the total load threshold being met. Within the set of continuous variables, Xₜ may indicate the ratio of PVU 12 activation at a time step of t where, if Xₜ is one, the PVU 12 is fully on, and if Xₜ is zero, the PVU 12 is off. The PVU 12 turndown may allow the MIP 60 schema to limit the thermal energy source when the thermal energy cannot be accepted by the hot source 22. The continuous variable, Lt, may indicate the PVU 12 electrical energy to the load. The continuous variables, Cₜ and Hₜ, may indicate the electrical energy to the chiller and the heat pump. The Oₜ variable may represent the ORC engine 26 electrical energy to the load. The Vᵢₜ variable may represent the effective ORC engine 26 value given the associated time step. As such, the MIP 60 schema comprises 8nₜ continuous variables where nₜ may indicate the number of time steps considered. Within the set of binary variables,

$${b}_{t}^{CH} , {b}_{t}^{HP} , and {b}_{t}^{ORC} ,$$

may indicate component activation decisions at a time step t. Binary variables

$${b}_{t}^{RE 0} , {b}_{t}^{CS 0} , and {b}_{t}^{HS 0} ,$$

may indicate the zero state of the recuperator, the cold store, and the hot store. The remaining binary variables may indicate availability at given thresholds and mark conjunctions necessary to identify the ORC engine operation mode.

The objective function for the fixed-capacity case may be defined as the weighted sum of two sub-goals. The first goal, f₁, is to minimize the total load residual using Equation (1), where the total load residual may be the energy not provided to meet the load demand. The second goal, f₂, is to reduce the energy wasted given the total energy available using Equation (2). The PEₜ in Equation (2) may represent the PVU 12 energy at time t. The second goal may ensure that any excess energy available after the load allocation is not wasted. The first goal may be given higher weight stipulation by priority.

$${f}_{1} = {\sum }_{t = 1}^{{n}_{t}} ( {LOAD}_{t} - {L}_{t} - {O}_{t} ) \qquad ( 1 )$$

$${f}_{2} = {\sum }_{t = 1}^{{n}_{t}} ( {PE}_{t} - {L}_{t} - {C}_{t} - {H}_{t} ) \qquad ( 2 )$$

The turndown conditions on the chiller, heat pump, and ORC engine 26 may limit the operational bounds when the turndown conditions are activated. The following stipulations may ensure that each component is bound between its lower and upper limit if the binary activation switch is one, and is zero otherwise. The chiller range operational bounds may be represented as

$${b}_{t}^{CH} {C}_{min} \leq {C}_{t} \leq {b}_{t}^{CH} {C}_{max} ,$$

the heat pump range operational bound may be represented as

$${b}_{t}^{HP} {H}_{min} \leq {H}_{t} \leq {b}_{t}^{HP} {H}_{max} ,$$

and the ORC engine 26 range operation bound may be represented as

$${b}_{t}^{ORC} {O}_{min} \leq {O}_{t} \leq {b}_{t}^{ORC} {O}_{max} .$$

in addition, the energy available subject to the PVU level may be greater than or equal to the energy allocated, as seen in Equation (3). The energy delivered to the load may be less than or equal to the load demand, as seen in Equation (4).

$${X}_{t} {PE}_{t} \geq {L}_{t} + {C}_{t} + {H}_{t} \qquad ( 3 )$$

$${L}_{t} + {O}_{t} \leq {LOAD}_{t} \qquad ( 4 )$$

In the MIP 60 schema, the operational conditions may constrain the model. As such, PEₜ<Cₘᵢₙ+Hₘᵢₙ may assert that if the energy available at time step t is less than that to run both the heat pump and the chiller, then only one component may be active. PEₜ<Cₘᵢₙ and PEₜ<Hₘᵢₙ may enforce the component deactivation if the available energy is below the lower bound. However, if the available energy at time step t is negligible, the chiller, the heat pump, and the PVU 12 to the load may all be inactive. Similarly, if the available energy is less than the load, all of the energy from the PVU 12 may be allocated to the load, while the chiller and heat pump may remain zero.

Further evaluation of the MIP 60 schema may be performed for the hot store level, cold store level, and the recuperator level. First, the hot store level,

$$H {S}_{t}^{l e v e l} ,$$

may be normalized between 0 and 1. Equation (10), as seen below, may establish the updated hot store level given the set of decisions made at time step t.

$$H {S}_{t}^{l e v e l} = H {S}_{t - 1}^{l e v e l} + {X}_{t} \frac{P {E}_{t}}{H {S}_{max}} + {C}_{t} \frac{C {H}_{t}^{H S}}{H {S}_{max} {C}_{max}} + {H}_{t} \frac{H {P}_{t}^{H S}}{H {S}_{max} {H}_{max}} … - {O}_{t} \frac{{ORC}_{t}^{HW 1}}{H {S}_{max} {O}_{max}} - {V}_{I C} \frac{( {ORC}_{t}^{HW 2} - {ORC}_{t}^{HW 1} )}{H {S}_{max} {O}_{max}} … - {V}_{2 t} \frac{( {ORC}_{t}^{HW 3} - {ORC}_{t}^{HW 1} )}{H {S}_{max} {O}_{max}} + {V}_{3 t} \frac{( {ORC}_{t}^{HW 2} - {ORC}_{t}^{HW 1} )}{H {S}_{max} {O}_{max}} \qquad ( 10 )$$

The cold store level,

$${CS}_{t}^{l e v e l} ,$$

may be normalized between 0 and 1. Equation (11), as seen below, may establish the updated cold store level given the set of decisions made at time step t.

$$C {S}_{t}^{l e v e l} = C {S}_{t - 1}^{l e v e l} + {C}_{t} \frac{C {H}_{t}^{CS}}{{CS}_{max} {O}_{max}} - {O}_{t} \frac{O R {C}_{t}^{CW 1}}{{CS}_{max} {O}_{max}} … - {V}_{1 t} \frac{( {ORC}_{t}^{CW 2} - {ORC}_{t}^{CW 1} )}{C {S}_{max} {O}_{max}} - {V}_{2 t} \frac{( {ORC}_{t}^{CW 3} - {ORC}_{t}^{CW 1} )}{C {S}_{max} {O}_{max}} + {V}_{3 t} \frac{( {ORC}_{t}^{CW 2} - {ORC}_{t}^{CW 1} )}{C {S}_{max} {O}_{max}} \qquad ( 11 )$$

The recuperator level,

$$R {E}_{t}^{l e v e l} ,$$

may be normalized between 0 and 1. Equation (12), as seen below, may establish the updated recuperator level given the set of decisions made at time step t.

$$R {E}_{t}^{l e v e l} = R {E}_{t - 1}^{l e v e l} + {C}_{t} \frac{C {H}_{t}^{R E}}{R {E}_{max} {C}_{max}} + {H}_{t} \frac{H {P}_{t}^{R E}}{R {E}_{max} {H}_{max}} - {O}_{t} \frac{O R {C}_{t}^{RE 1}}{R {E}_{max} {O}_{max}} … - {V}_{1 t} \frac{( {ORC}_{t}^{R E 2} - {ORC}_{t}^{R E 1} )}{R {E}_{max} {O}_{max}} - {V}_{2 t} \frac{( {ORC}_{t}^{R E 3} - {ORC}_{t}^{R E 1} )}{R {E}_{max} {O}_{max}} + {V}_{3 t} \frac{( {ORC}_{t}^{RE 2} - {ORC}_{t}^{RE 1} )}{R {E}_{max} {O}_{max}} \qquad ( 12 )$$

A zero-level indication may set the binary availability variables for the recuperator, cold store 24, and hot store 22, by way of ‘available’ indicator variables Z₁ₜ, Z₂ₜ, and Z₃ₜ. These conditions then indicate the zero-level condition for the recuperator, the cold store 24, and the hot store 22 using Equations (13)-(15).

$${b}_{t}^{RE 0} = 1 - {Z}_{1 t} \qquad ( 13 )$$

$${b}_{t}^{CS 0} = 1 - {Z}_{2 t} \qquad ( 14 )$$

$${b}_{t}^{HS 0} = 1 - {Z}_{3 t} \qquad ( 15 )$$

To determine if the conjunction is imposed at time step t (indicative of the mode of operation) the necessary conditions for

$$b c o {n}_{t}^{1} , b c o {n}_{t}^{2} , and {bcon}_{t}^{3}$$

may be checked. For example, the conjunction

$$b c o {n}_{t}^{1}$$

may be true if the ORC engine 26 is on

$$( i . e . , {b}_{t}^{O R C} = 1 )$$

and the recuperator is zero

$$( i . e . , {b}_{t}^{R E 0} = 1 ) .$$

The conjunction

$$b c o {n}_{t}^{2}$$

may be true if the ORC engine 26 is on and the cold store is zero. The conjunction

$$b c o {n}_{t}^{3}$$

may be true if the both

$$b c o {n}_{t}^{2} and {bcon}_{t}^{1}$$

are true. The effective ORC engine 26 mode of operation may then be given based on the active conjunction. The active conjunction may serve to identify the mode of operation. The mode of operation may include the recuperator 80 and cold store 82 available, the cold store 82 available and recuperator 80 unavailable, the recuperator 80 and cold store 82 unavailable, and the like. For example, the effective value (V₁ₜ) may be less than or equal to the ORC engine 26 decision (Oₜ) if conjunction

$$( b c o {n}_{t}^{1} )$$

is true, where Oₜ may be smaller than the large scalar term (M) by design. However, if the conjunction is false, the effective value (V₁ₜ) may be bound between [−M 0]. Thus, the effective value may be the same as the ORC engine 26 as the ORC decision when the given conjunction is true. The effective values based on the active conjunction may use Equations (10)-(12) to indicate the effective impact on the hot store 22, cold store 24, and recuperator.

The imposition of pre-allocation conditions may enforce the available energy from the PVU 12 to prioritize delivery to the load at each time step. Thus, the excess energy available may be distributed to the heat pump or the chiller. As such, the energy from the PVU 12 may be more effectively sourced than energy retrieved from the ORC engine 26. Moreover, reducing energy losses may be more conducive to achieving a higher capacity factor.

After the various calculations made above, the MIP 60 schema may be used to allocate energy to the appropriate components. In the MIP 60 schema, PVU-T and PVU-E, at block 62 and block 64, respectively, may define the thermal and electrical energy sources from the PVU 12. The thermal energy source from block 62 may charge the hot store directly at block 78. The electrical energy source from block 64 may, at block 66, be split between block 68, block 70, and block 72. The calculated electrical energy wasted, Wₜ, may move from block 66 to block 68. The calculated electrical energy coming from the PVU 12 to the load, Lt, may move from block 66 to block 70. The calculated electrical energy remaining, Rt, may move from block 66 to block 72. At block 72, the electrical energy remaining, Rt, may split based on the calculated heat pump electrical energy, Hₜ, used by the heat pump at block 74 and the calculated chiller electrical energy, Cₜ, used by the chiller at block 76. The heat pump at block 74 and the chiller at block 76 may charge the hot store at block 78, the cold store at block 82, and the recuperator at block 80 using the electrical energy distributed to the heat pump at block 74 and the chiller at block 76. The charged hot store at block 78, cold store at block 82, and recuperator at block 80 may be distributed to the ORC engine at block 84. The electrical energy generated from the ORC engine at block 84 may then move to block 86 based on the calculation of the electrical energy from the ORC engine 26 going to the load, Oₜ. The calculated electrical energy from the ORC engine 26 going to the load, Oₜ, may then move to the load at block 88.

FIG. 4 illustrates a representation of a RBM 90 schema described with regard to FIG. 2 to yield a high-capacity energy allocation for each component of the long-duration solar energy system 10. Starting with block 92 and block 94, PVU-T and PVU-E may define the thermal and electrical energy sources from the PVU 12, respectively. The thermal energy source from block 92 may charge the hot store directly at block 106. The electrical energy source from block 94 may be used to provision the electrical energy at a delivery mechanism (at 98) to allocate the electrical energy to the load (at 116), run the heat pump (at 102) or the chiller (at 104), be deemed as wasted energy (at 118), or any combination thereof. The heat pump and chiller may charge the hot store 22, cold store 24, and recuperator levels accordingly. The ORC engine 26 may provision the electrical energy at an ORC delivery mechanism (at 114) and provide energy to the load (at 116) as needed.

In the RBM 90 schema, code may be implemented to make decisions sequentially one time step at a time. The impact of the selected decision may assess the impact of the decision on the long-duration solar energy system 10. As such, the PVU-T at block 92 may charge the hot store when a PVU level may be fixed at one, in which the PVU level fixed at one may indicate that the long-duration solar energy system 10 may be on and the PVU level fixed at zero may indicate that the energy system 10 may be off (e.g., no sunshine is shining on the mirror field). The available electrical energy measured from energy source at block 94 may be indicated at block 96. The electrical energy at block 96 may be split at block 98 to deliver electrical energy to the load at block 116, and the remaining electrical energy may flow to block 100. The remaining electrical energy at block 100 may then be split between the heat pump at 102 and the chiller at 104 to power each component. At this stage of the RBM 90 schema, decisions about the allocation of the remaining electrical energy may be made for the first timestep. The decision about the allocation may be based on a pre-defined ratio, by preference for hot or cold charge, set as a function of the current charge levels, made to evenly allocate between the hot and cold stores, to minimize the amount wasted, and the like. If the heat pump at block 102 or chiller at block 104 cannot accept the energy, the energy may go to waste where it may be re-distributed to the other components. The heat pump at block 102 and the chiller at block 104 may charge the hot store at block 106, the cold store at block 110, and the recuperator at block 108 using the remaining electrical energy distributed to the heat pump at block 102 and the chiller at block 104. The charged hot store at block 106, cold store at block 108, and recuperator at block 108 may be distributed to the ORC engine at block 112. The electrical energy generated from the ORC engine at block 112 is then be delivered to the load at block 116. The RMB 90 schema may restart for the next timestep to allocate the thermal and electrical energy for the long-duration solar energy system 10.

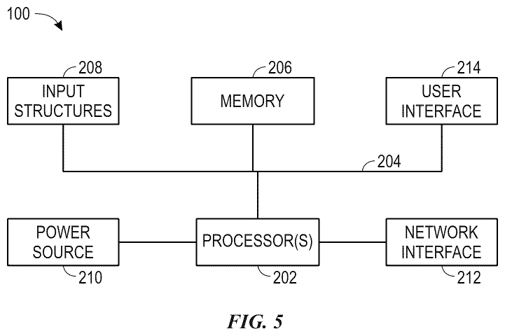

FIG. 5 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors (e.g., processing circuitry) capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 5, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

The subject matter described in detail above may be defined by one or more clauses, as set forth below.

A system includes a processing system comprising one or more processors and a memory storing instructions that, when executed by the processing system, are configured to cause the processing system to perform operations. The memory storing instructions includes receiving input data, where the input data includes one or more fixed data variables, one or more temporal data variables, or any combination thereof, setting one or more static properties based on the input data, providing the one or more static properties to a model of one or more components of an energy system, generating a plurality of performance curves, where each performance curve of the plurality of performance curves corresponds to a respective component of the one or more components, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI.

The system of the preceding clause, where the selected mathematical model is a mixed integer program (MIP), where generating the allocation of energy via the MIP includes receiving a set of continuous variables and a set of binary variables, activating one or more equations, where the one or more equations engages the set of continuous variables and the set of binary variables, and generating the allocation of energy using one or more equations based on the set of continuous variables, the set of binary variables, and an activated conjunction.

The system of the preceding clause, where the selected mathematical model is a rules-based model (RBM), where generating the allocation of energy via the RBM includes receiving a first amount of energy to the energy system at a first time step, receiving a selected mode of operation, generating a first allocation of energy to the one or more components of the energy system at the first time step based on the first amount of energy, and the selected mode of operation, receiving a second amount of energy to the energy system at a second time step, and generating a second allocation of energy to the one or more components of the energy system at the second time step based on the second amount of energy, the selected mode of operation, and the first allocation of energy.

The system of any preceding clause, where the activated conjunction is configured to indicate one or more components available to receive energy.

The system of any preceding clause, where the mode of operation includes a first mode of operation in which a recuperator and a cold store of the one or more components are available to receive energy.

The system of any preceding clause, where the mode of operation includes a second mode of operation in which a recuperator of the one or more components is unavailable to receive energy.

The system of any preceding clause, where the mode of operation includes a third mode of operation in which a cold store of the one or more components is unavailable to receive energy.

The system of any preceding clause, where the energy system comprises a long-duration solar energy system.

The system of any preceding clause, where the allocation of energy enables the long-duration solar energy system to meet a threshold capacity factor such that the long-duration solar energy system continues to operate when the long-duration solar energy system is not receiving sunlight.

A tangible, non-transitory, computer-readable medium comprising instructions that, when executed by processing circuitry, are configured to cause the processing circuitry to perform operations including receiving input data, where the input data includes one or more fixed data variables, one or more temporal data variables, or any combination thereof, setting one or more static properties based on the input data, providing the one or more static properties to a model of one or more components of an energy system, generating a plurality of performance curves, where each performance curve of the plurality of performance curves corresponds to a respective component of the one or more components, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI.

The tangible, non-transitory, computer-readable medium of the preceding clause, where the selected mathematical model is a mixed integer program (MIP), where generating the allocation of energy via the MIP includes receiving a set of continuous variables and a set of binary variables, activating one or more equations, where the one or more equations engages the set of continuous variables and the set of binary variables, and generating the allocation of energy using one or more equations based on the set of continuous variables, the set of binary variables, and an activated conjunction.

The tangible, non-transitory, computer-readable medium of the preceding clause, where the selected mathematical model is a rules-based model (RBM), where generating the allocation of energy via the RBM includes receiving a first amount of energy to the energy system at a first time step, receiving a selected mode of operation, generating a first allocation of energy to the one or more components of the energy system at the first time step based on the first amount of energy, and the selected mode of operation, receiving a second amount of energy to the energy system at a second time step, and generating a second allocation of energy to the one or more components of the energy system at the second time step based on the second amount of energy, the selected mode of operation, and the first allocation of energy.

The tangible, non-transitory, computer-readable medium of any preceding clause, where the activated conjunction is configured to indicate one or more components available to receive energy.

The tangible, non-transitory, computer-readable medium of any preceding clause, where the mode of operation includes a first mode of operation in which a recuperator and a cold store of the one or more components are available to receive energy.

The tangible, non-transitory, computer-readable medium of any preceding clause, where the mode of operation includes a second mode of operation in which a recuperator of the one or more components is unavailable to receive energy.

The tangible, non-transitory, computer-readable medium of any preceding clause, where the mode of operation includes a third mode of operation in which a cold store of the one or more components is unavailable to receive energy.

The tangible, non-transitory, computer-readable medium of any preceding clause, where the energy system comprises a long-duration solar energy system.

A method including receiving input data, where the input data includes one or more fixed data variables, one or more temporal data variables, or any combination thereof, setting one or more static properties based on the input data, providing the one or more static properties to a model of one or more components of an energy system, generating a plurality of performance curves, where each performance curve of the plurality of performance curves corresponds to a respective component of the one or more components, transmitting the plurality of performance curves for display via a graphical user interface (GUI), receiving, via the GUI, an input indicative of a selection of a mathematical model, engaging the selected mathematical model, generating, using the selected mathematical model, an allocation of energy to the one or more components of the energy system, and transmitting the allocation for display via the GUI.

The method of the preceding clause, where the selected mathematical model is a mixed integer program (MIP), where generating the allocation of energy via the MIP includes receiving a set of continuous variables and a set of binary variables, activating one or more equations, where the one or more equations engages the set of continuous variables and the set of binary variables, and generating the allocation of energy using one or more equations based on the set of continuous variables, the set of binary variables, and an activated conjunction.

The method of the preceding clause, where the selected mathematical model is a rules-based model (RBM), where generating the allocation of energy via the RBM includes receiving a first amount of energy to the energy system at a first time step, receiving a selected mode of operation, generating a first allocation of energy to the one or more components of the energy system at the first time step based on the first amount of energy, and the selected mode of operation, receiving a second amount of energy to the energy system at a second time step, and generating a second allocation of energy to the one or more components of the energy system at the second time step based on the second amount of energy, the selected mode of operation, and the first allocation of energy.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processing system comprising one or more processors;
a memory storing instructions that, when executed by the processing system, are configured to cause the processing system to perform operations comprising:
receiving input data, wherein the input data comprises one or more fixed data variables, one or more temporal data variables, or any combination thereof;
setting one or more static properties based on the input data;
providing the one or more static properties to a model of one or more components of an energy system;
generating a plurality of performance curves, wherein each performance curve of the plurality of performance curves corresponds to a respective component of the one or more components;
transmitting the plurality of performance curves for display via a graphical user interface (GUI);
receiving, via the GUI, an input indicative of a selection of a mathematical model;
engaging the selected mathematical model;
generating, using the selected mathematical model, an allocation of energy to the one or more components of the energy system; and
transmitting the allocation for display via the GUI.

2. The system of claim 1, wherein the selected mathematical model is a mixed integer program (MIP), wherein generating the allocation of energy via the MIP comprises:
receiving a set of continuous variables and a set of binary variables;
activating one or more equations, wherein the one or more equations engages the set of continuous variables and the set of binary variables; and
generating the allocation of energy using one or more equations based on the set of continuous variables, the set of binary variables, and an activated conjunction.

3. The system of claim 1, wherein the selected mathematical model is a rules-based model (RBM), wherein generating the allocation of energy via the RBM comprises:
receiving a first amount of energy to the energy system at a first time step;
receiving a selected mode of operation;
generating a first allocation of energy to the one or more components of the energy system at the first time step based on the first amount of energy, and the selected mode of operation;
receiving a second amount of energy to the energy system at a second time step; and
generating a second allocation of energy to the one or more components of the energy system at the second time step based on the second amount of energy, the selected mode of operation, and the first allocation of energy.

4. The system of claim 2, wherein the activated conjunction is configured to indicate one or more components available to receive energy.

5. The system of claim 3, wherein the mode of operation comprises a first mode of operation in which a recuperator and a cold store of the one or more components are available to receive energy.

6. The system of claim 3, wherein the mode of operation comprises a second mode of operation in which a recuperator of the one or more components is unavailable to receive energy.

7. The system of claim 3, wherein the mode of operation comprises a third mode of operation in which a cold store of the one or more components is unavailable to receive energy.

8. The system of claim 1, wherein the energy system comprises a long-duration solar energy system.

9. The system of claim 7, wherein the allocation of energy enables the long-duration solar energy system to meet a threshold capacity factor such that the long-duration solar energy system continues to operate when the long-duration solar energy system is not receiving sunlight.

10. A tangible, non-transitory, computer-readable medium comprising instructions that, when executed by processing circuitry, are configured to cause the processing circuitry to perform operations comprising:
receiving input data, wherein the input data comprises one or more fixed data variables, one or more temporal data variables, or any combination thereof;
setting one or more static properties based on the input data;
providing the one or more static properties to a model of one or more components of an energy system;
generating a plurality of performance curves, wherein each performance curve of the plurality of performance curves corresponds to a respective component of the one or more components;
transmitting the plurality of performance curves for display via a graphical user interface (GUI);
receiving, via the GUI, an input indicative of a selection of a mathematical model;
engaging the selected mathematical model;
generating, using the selected mathematical model, an allocation of energy to the one or more components of the energy system; and
transmitting the allocation for display via the GUI.

11. The tangible, non-transitory, computer-readable medium of claim 10, wherein the selected mathematical model is a mixed integer program (MIP), wherein generating the allocation of energy via the MIP comprises:
receiving a set of continuous variables and a set of binary variables;
activating one or more equations, wherein the one or more equations engages the set of continuous variables and the set of binary variables; and
generating the allocation of energy using one or more equations based on the set of continuous variables, the set of binary variables, and an activated conjunction.

12. The tangible, non-transitory, computer-readable medium of claim 10, wherein the selected mathematical model is a rules-based model (RBM), wherein generating the allocation of energy via the RBM comprises:
receiving a first amount of energy to the energy system at a first time step;
receiving a selected mode of operation;
generating a first allocation of energy to the one or more components of the energy system at the first time step based on the first amount of energy, and the selected mode of operation;
receiving a second amount of energy to the energy system at a second time step; and
generating a second allocation of energy to the one or more components of the energy system at the second time step based on the second amount of energy, the selected mode of operation, and the first allocation of energy.

13. The tangible, non-transitory, computer-readable medium of claim 11, wherein the activated conjunction is configured to indicate one or more components available to receive energy.

14. The tangible, non-transitory, computer-readable medium of claim 12, wherein the mode of operation comprises a first mode of operation in which a recuperator and a cold store of the one or more components are available to receive energy.

15. The tangible, non-transitory, computer-readable medium of claim 12, wherein the mode of operation comprises a second mode of operation in which a recuperator of the one or more components is unavailable to receive energy.

16. The tangible, non-transitory, computer-readable medium of claim 12, wherein the mode of operation comprises a third mode of operation in which a cold store of the one or more components is unavailable to receive energy.

17. The tangible, non-transitory, computer-readable medium of claim 12, wherein the energy system comprises a long-duration solar energy system.

18. A method, comprising:
receiving input data, wherein the input data comprises one or more fixed data variables, one or more temporal data variables, or any combination thereof;
setting one or more static properties based on the input data;
providing the one or more static properties to a model of one or more components of an energy system;
generating a plurality of performance curves, wherein each performance curve of the plurality of performance curves corresponds to a respective component of the one or more components;
transmitting the plurality of performance curves for display via a graphical user interface (GUI);
receiving, via the GUI, an input indicative of a selection of a mathematical model;
engaging the selected mathematical model;
generating, using the selected mathematical model, an allocation of energy to the one or more components of the energy system; and
transmitting the allocation for display via the GUI.

19. The method of claim 16, wherein the selected mathematical model is a mixed integer program (MIP), wherein generating the allocation of energy via the MIP comprises:
receiving a set of continuous variables and a set of binary variables;
activating one or more equations, wherein the one or more equations engages the set of continuous variables and the set of binary variables; and
generating the allocation of energy using one or more equations based on the set of continuous variables, the set of binary variables, and an activated conjunction.

20. The method of claim 16, wherein the selected mathematical model is a rules-based model (RBM), wherein generating the allocation of energy via the RBM comprises:
receiving a first amount of energy to the energy system at the first time step;
receiving a selected mode of operation;
generating a first allocation of energy to the one or more components of the energy system at the first time step based on the first amount of energy, and the selected mode of operation;
receiving a second amount of energy to the energy system at a second time step; and
generating a second allocation of energy to the one or more components of the energy system at the second time step based on the second amount of energy, the selected mode of operation, and the first allocation of energy.
